(19) United States
(12) Patent Application Publication
(10) Pub. No.: US 2016/0021676 A1
(43) Pub. Date: Jan. 21, 2016

(54) BASE STATION AND COMMUNICATION CONTROL METHOD

(71) Applicant: KYOCERA CORPORATION, Kyoto-shi, Kyoto (JP)

(72) Inventors: Chiharu YAMAZAKI, Ota-ku (JP); Masato FUJISHIRO, Yokohama-shi (JP)

(73) Assignee: Kyocera Corporation, Kyoto-shi, Kyoto (JP)

(21) Appl. No.: 14/767,868

(22) PCT Filed: Feb. 18, 2014
(86) PCT No.: PCT/JP2014/053739

§ 371 Date: Aug. 13, 2015

Related U.S. Application Data
(60) Provisional application No. 61/765,901, filed on Feb. 18, 2013.

(51) Int. Cl. H04W 72/10; H04B 7/02; H04W 4/00

(52) U.S. Cl. CPC H04W 72/10; H04W 4/005; H04B 7/024; H04W 84/042

(57) ABSTRACT

A base station configured to be used in a mobile communication system that supports cellular communication in which a data path passes through a core network, and D2D communication that is direct device-to-device communication in which a data path does not pass through the core network, comprises: a control unit configured to assign a dedicated radio resource not shared with the D2D communication or a shared radio resource shared with the D2D communication to each of a plurality of cellular terminals that perform the cellular communication. The control unit comprises: a scheduler configured to select a cellular terminal, to which the shared radio resource is assigned, from the plurality of cellular terminals according to assignment priority of the shared radio resource. The scheduler calculates the assignment priority for each of the plurality of cellular terminals such that influence of interference between the cellular communication and the D2D communication is alleviated.

### TECHNICAL FIELD

The present invention relates to a mobile communication system that supports D2D communication, a base station, a user terminal, and a processor.

### BACKGROUND ART

In 3GPP (3rd Generation Partnership Project) which is a project aiming to standardize a mobile communication system, the introduction of Device to Device (D2D) communication is discussed as a new function after Release 12 (see Non Patent Document 1).

In the D2D communication, a plurality of neighboring user terminals (a user terminal group) perform direct communication without passing through a core network. That is, a data path of the D2D communication does not pass through the core network. On the other hand, a data path of normal communication (cellular communication) of a mobile communication system passes through the core network.

### PRIOR ART DOCUMENT

### Non-Patent Document

Non Patent Document 1: 3GPP technical report “TR 22.803 V12.0.0” December 2012

### SUMMARY OF THE INVENTION

In order to prevent interference between cellular communication and D2D communication in a mobile communication system, it is considered to control a radio resource used in communication to be different between the cellular communication and the D2D communication.

However, in such a method, it is difficult to improve the use efficiency of a radio resource in the mobile communication system.

Therefore, the present invention provides a base station and a communication control method, by which it is possible to improve the use efficiency of a radio resource while alleviating the influence of interference.

A base station according to an embodiment is used in a mobile communication system that supports cellular communication in which a data path passes through a core network, and D2D communication that is direct device-to-device communication in which a data path does not pass through the core network. The base station comprises: a control unit configured to be assign a dedicated radio resource not shared with the D2D communication or a shared radio resource shared with the D2D communication to each of a plurality of cellular terminals that perform the cellular communication. The control unit comprises: a scheduler configured to be select a cellular terminal, to which the shared radio resource is assigned, from the plurality of cellular terminals according to assignment priority of the shared radio resource. The scheduler calculates the assignment priority for each of the plurality of cellular terminals such that influence of interference between the cellular communication and the D2D communication is alleviated.

### BRIEF DESCRIPTION OF THE DRAWINGS

FIG. 1 is a configuration diagram of an LTE system.

FIG. 2 is a block diagram of UE.

FIG. 3 is a block diagram of eNB.

FIG. 4 is a protocol stack diagram of a radio interface in the LTE system.

FIG. 5 is a configuration diagram of a radio frame used in the LTE system.

FIG. 6 is a diagram illustrating a data path in cellular communication.

FIG. 7 is a diagram illustrating a data path in D2D communication.

FIG. 8 is a diagram for describing an operation environment according to the first embodiment.

FIG. 9 is a diagram for describing the dedicated resource assignment scheme.

FIG. 10 is a diagram for describing the shared resource assignment scheme.

### DESCRIPTION OF THE EMBODIMENT

### Overview of Embodiment

A base station according to a first embodiment and a second embodiment is used in a mobile communication system that supports cellular communication in which a data path passes through a core network, and D2D communication that is direct device-to-device communication in which a data path does not pass through the core network. The base station comprises: a control unit configured to be assign a dedicated radio resource not shared with the D2D communication or a shared radio resource shared with the D2D communication to each of a plurality of cellular terminals that perform the cellular communication. The control unit comprises: a scheduler configured to be select a cellular terminal, to which the shared radio resource is assigned, from the plurality of cellular terminals according to assignment priority of the shared radio resource. The scheduler calculates the assignment priority for each of the plurality of cellular terminals such that influence of interference between the cellular communication and the D2D communication is alleviated.

In a first embodiment, the scheduler calculates the assignment priority for each of the plurality of cellular terminals such that the shared radio resource is not continuously assigned to a same cellular terminal.

In another embodiment, the scheduler calculates the assignment priority for each of the plurality of cellular terminals so that the shared radio resource is not periodically continuously assigned to the same cellular terminal.

In a first embodiment, the scheduler calculates the assignment priority for each of the plurality of cellular terminals on the basis of a passage time after the shared radio resource is finally assigned. The assignment priority is adjusted to be lower as the passage time is shorter.

In a second embodiment, the scheduler calculates the assignment priority for each of the plurality of cellular terminals such that the shared radio resource is preferentially assigned to a cellular terminal in the vicinity of the base station among the plurality of cellular terminals.

In a second embodiment, the scheduler calculates the assignment priority for each of the plurality of cellular terminals on the basis of path loss between the base station and each of the plurality of cellular terminals. The assignment priority is adjusted to be higher as the path loss is smaller.

In another embodiment, the scheduler calculates the assignment priority for each of the plurality of cellular terminals on the basis of path loss between the base station and each of the plurality of cellular terminals and pass loss between another base station located in the vicinity of the base station and each of the plurality of cellular terminals. The assignment priority is adjusted to be higher as either one of the path loss with respect to the base station or the path loss with respect to the another base station is smaller.

In another embodiment, the assignment priority for a cellular terminal in which the base station and the another base station function as a CoMP cooperating set in an uplink, out of the plurality of user terminals, is adjusted to be higher as either one of the path loss with respect to the base station or the path loss with respect to the another base station is smaller.

In another embodiment, the assignment priority for a cellular terminal in which transmission power is controlled according to the path loss with respect to the another base station, out of the plurality of cellular terminals, is adjusted to be higher as either one of the path loss with respect to the base station and the path loss with respect to the another base station is smaller.

In a modification of the second embodiment, the scheduler calculates the assignment priority for each of the plurality of cellular terminals on the basis of uplink transmission power. The assignment priority is adjusted to be higher as the uplink transmission power is smaller.

In a second embodiment and a first embodiment, in order to calculate the assignment priority of the shared radio resource, a scheduling algorithm, which is different from a scheduling algorithm used in order to calculate assignment priority of the dedicated radio resource, is used.

A communication control method according to the first embodiment and the second embodiment is used in a mobile communication system that supports cellular communication in which a data path passes through a core network, and D2D communication that is direct device-to-device communication in which a data path does not pass through the core network. The communication control method comprises: a step A of selecting, by a base station, a cellular terminal, to which a shared radio resource is assigned, from a plurality of cellular terminals that perform the cellular communication, according to assignment priority of the shared radio resource, the base station assigning a dedicated radio resource not shared with the D2D communication or the shared radio resource shared with the D2D communication to each of the plurality of cellular terminals. In the step A, the base station calculates the assignment priority for each of the plurality of cellular terminals such that influence of interference between the cellular communication and the D2D communication is alleviated.

### First Embodiment

Hereinafter, with reference to the accompanying drawings, description will be provided for an embodiment in a case where D2D communication is introduced to a mobile communication system (an LTE system) configured based on the 3GPP standards.

(LTE System)

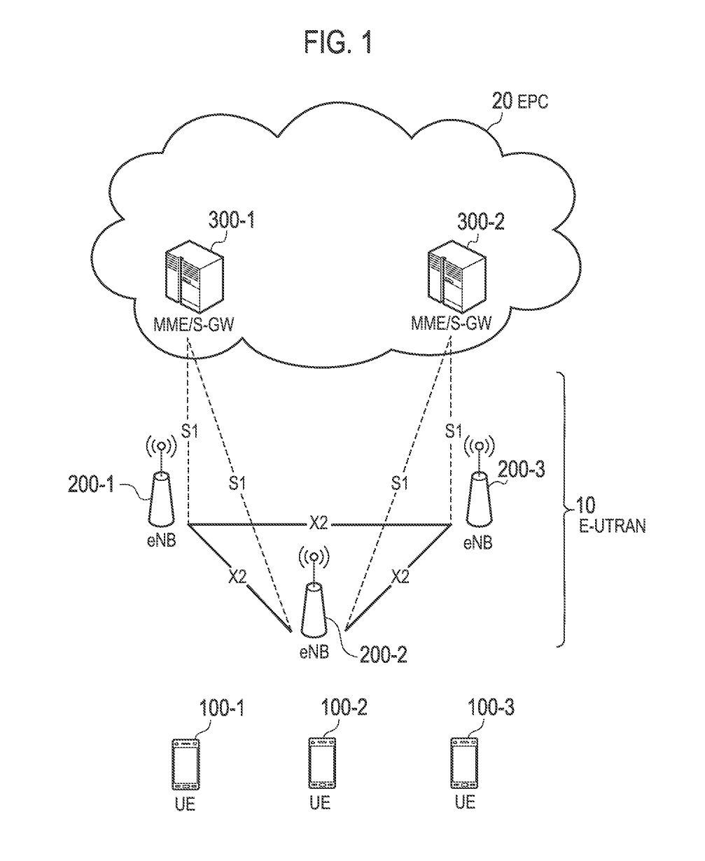

FIG. 1 is a configuration diagram of an LTE system according to the first embodiment. As illustrated in FIG. 1, the LTE system includes a plurality of UEs (User Equipments) 100, E-UTRAN (Evolved-Universal Terrestrial Radio Access Network) 10, and EPC (Evolved Packet Core) 20. The E-UTRAN 10 corresponds to a radio access network and the EPC 20 corresponds to a core network. The E-UTRAN 10 and the EPC 20 configure a network of the LTE system.

The UE 100 is a mobile communication device and performs radio communication with a cell (a serving cell) with which a connection is established. The UE 100 corresponds to a user terminal.

The E-UTRAN 10 includes a plurality of eNBs 200 (evolved Node-Bs). The eNB 200 corresponds to a base station. The eNB 200 configures one or a plurality of cells and performs radio communication with the UE 100 which establishes a connection with the cell of the eNB 200. It is noted that the “cell” is used as a term indicating a minimum unit of a radio communication area, and is also used as a term indicating a function of performing radio communication with the UE 100.

The eNB 200, for example, has a radio resource management (RRM) function, a routing function of user data, and a measurement control function for mobility control and scheduling.

The EPC 20 includes a plurality of MME (Mobility Management Entity)/S-GWs (Serving-Gateways) 300. The MME is a network node for performing various mobility controls and the like for the UE 100 and corresponds to a controller. The S-GW is a network node that performs transfer control of user data and corresponds to a mobile switching center. The EPC 20 including the MME/S-GW 300 accommodates the eNB 200.

The eNBs 200 are connected mutually via an X2 interface. Furthermore, the eNB 200 is connected to the MME/S-GW 300 via an S1 interface.

Next, the configurations of the UE 100 and the eNB 200 will be described.

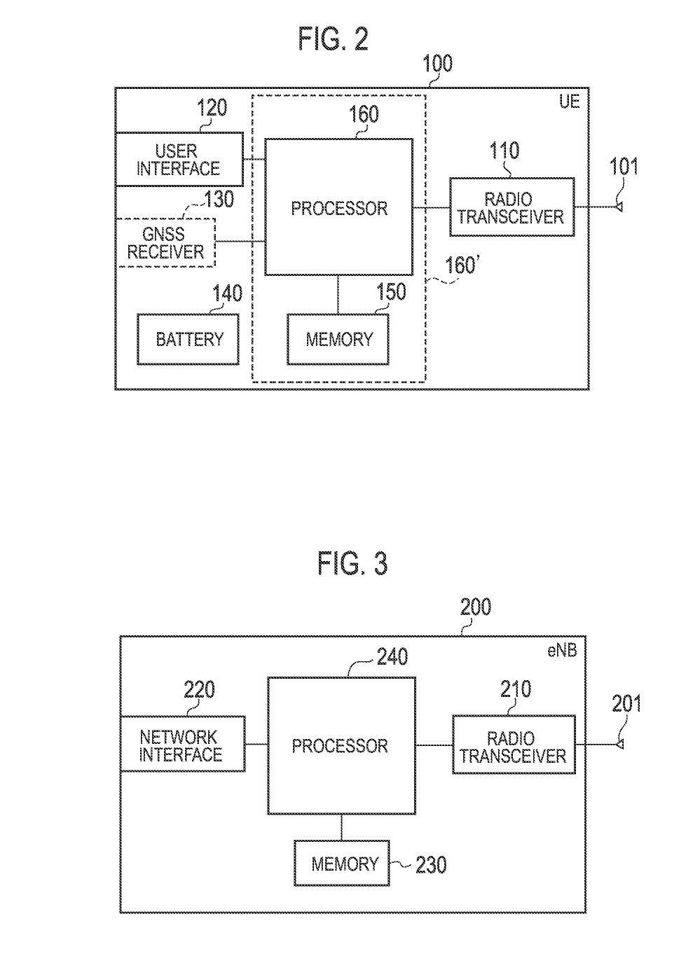

FIG. 2 is a block diagram of the UE 100. As illustrated in FIG. 2, the UE 100 includes an antenna 101, a radio transceiver 110, a user interface 120, a GNSS (Global Navigation Satellite System) receiver 130, a battery 140, a memory 150, and a processor 160. The memory 150 and the processor 160 configure a control unit. The UE 100 may not have the GNSS receiver 130. Furthermore, the memory 150 may be integrally formed with the processor 160, and this set (that is, a chip set) may be called a processor 160′.

The antenna 101 and the radio transceiver 110 are used to transmit and receive a radio signal. The antenna 101 includes a plurality of antenna elements. The radio transceiver 110 converts a baseband signal output from the processor 160 into the radio signal, and transmits the radio signal from the antenna 101. Furthermore, the radio transceiver 110 converts the radio signal received by the antenna 101 into the baseband signal, and outputs the baseband signal to the processor 160.

The user interface 120 is an interface with a user carrying the UE 100, and includes, for example, a display, a microphone, a speaker, various buttons and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes an antenna 201, a radio transceiver 210, a network interface 220, a memory 230, and a processor 240. The memory 230 and the processor 240 configure a control unit. In the first embodiment, the processor 240 has a function of the aforementioned scheduler. Furthermore, the memory 230 may be integrally formed with the processor 240, and this set (that is, a chip set) maybe called a processor.

The antenna 201 and the radio transceiver 210 are used to transmit and receive a radio signal. The antenna 201 includes a plurality of antenna elements. The radio transceiver 210 converts the baseband signal output from the processor 240 into the radio signal, and transmits the radio signal from the antenna 201. Furthermore, the radio transceiver 210 converts the radio signal received by the antenna 201 into the baseband signal, and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240. The processor 240 includes the baseband processor that performs modulation and demodulation, and encoding and decoding and the like on the baseband signal and a CPU that performs various processes by executing the program stored in the memory 230. The processor 240 executes various processes and various communication protocols described later.

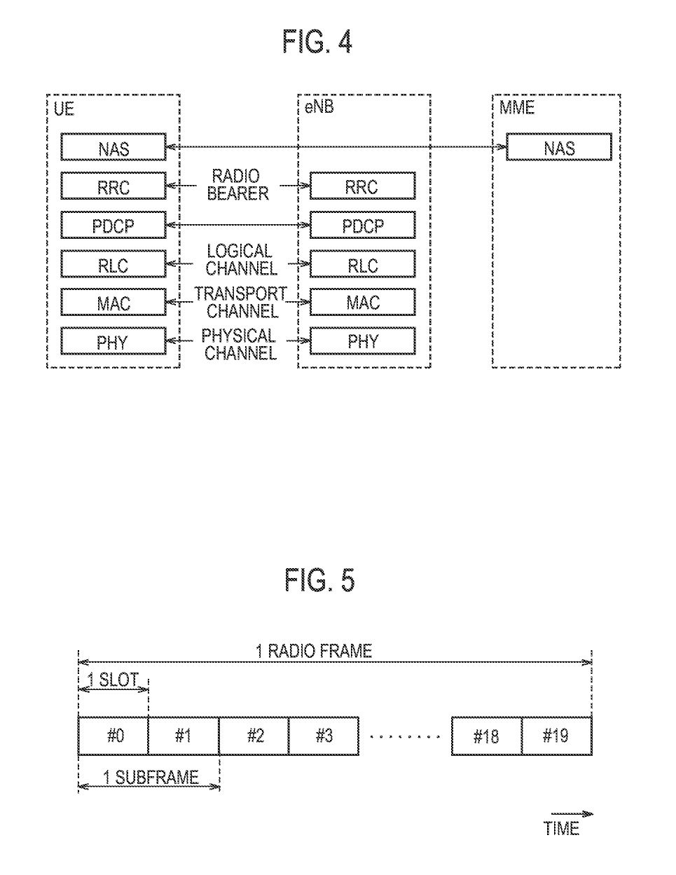

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, data is transmitted via the physical channel.

The MAC layer performs preferential control of data, and a retransmission process and the like by hybrid ARQ (HARQ). Between the MAC layer of the UE 100 and the MAC layer of the eNB 200, data is transmitted via a transport channel. The MAC layer of the eNB 200 includes a transport format of an uplink and a downlink (a transport block size and a modulation and coding scheme (MCS)) and a scheduler for determining a resource block to be assigned.

The RLC layer transmits data to an RLC layer of a reception side by using the functions of the MAC layer and the PHY layer. Between the RLC layer of the UE 100 and the RLC layer of the eNB 200, data is transmitted via a logical channel.

The PDCP layer performs header compression and decompression, and encryption and decryption.

The RRC layer is defined only in a control plane. Between the RRC layer of the UE 100 and the RRC layer of the eNB 200, a control message (an RRC message) for various types of setting is transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in a connected state (an RRC connected state), and when there is no RRC connection, the UE 100 is in an idle state (an RRC idle state).

A NAS (Non-Access Stratum) layer positioned above the RRC layer performs session management, mobility management and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Among radio resources assigned to the UE 100, a frequency resource can be specified by a resource block and a time resource can be specified by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data. Furthermore, in the downlink, reference signals, such as cell-specific reference signals (CRSs), are distributed and arranged in each subframe. The PDCCH carries a control signal. The control signal, for example, includes an uplink SI (Scheduling Information), a downlink SI, and a TPC bit. The uplink SI is information indicating the assignment of an uplink radio resource and the downlink SI is information indicating the assignment of a downlink radio resource. The TPC bit is information for instructing an increase or decrease in the uplink transmission power. These types of information are called downlink control information (DCI). The PDSCH carries a control signal and/or user data. For example, a downlink data region may be assigned only to the user data, or assigned such that the user data and the control signal are multiplexed.

In the uplink, both ends in the frequency direction of each subframe are control regions used as a physical uplink control channel (PUCCH) for mainly transmitting a control signal. Furthermore, the central portion in the frequency direction of each subframe is a region available as a physical uplink shared channel (PUSCH) for mainly transmitting user data. The PUCCH carries a control signal. The control signal, for example, includes CQI (Channel Quality Indicator), PMI (Precoding Matrix Indicator), RI (Rank Indicator), SR (Scheduling Request), and ACK/NACK. The CQI is information indicating downlink channel quality and is used for deciding a recommended modulation scheme and a coding rate to be used in downlink transmission, and the like. The PMI is information indicating a precoder matrix that is preferable to be used for the downlink transmission. The RI is information indicating the number of layers (the number of streams) available for the downlink transmission. The SR is information for requesting the assignment of an uplink radio resource (a resource block). The ACK/NACK is information indicating whether or not a signal transmitted via a downlink physical channel (for example, the PUSCH) has been successfully decoded. The PUSCH carries a control signal and/or user data. For example, an uplink data region may be assigned only to the user data, or assigned such that the user data and the control signal are multiplexed.

(D2D Communication)

The LTE system according to the first embodiment supports the D2D communication that is direct communication between UEs. Hereinafter, the D2D communication will be described in comparison with normal communication (cellular communication) of the LTE system.

In the cellular communication, a data path passes through the EPC 20 that is a core network. The data path indicates a communication path of user data (a user plane). On the other hand, in the D2D communication, the data path set between the UEs does not pass through the EPC 20. Thus, it is possible to reduce traffic load of the EPC 20.

The UE 100 discovers another UE 100 that exists in the vicinity of the UE 100, and starts the D2D communication (communication). The D2D communication includes a direct communication mode and a locally routed mode.

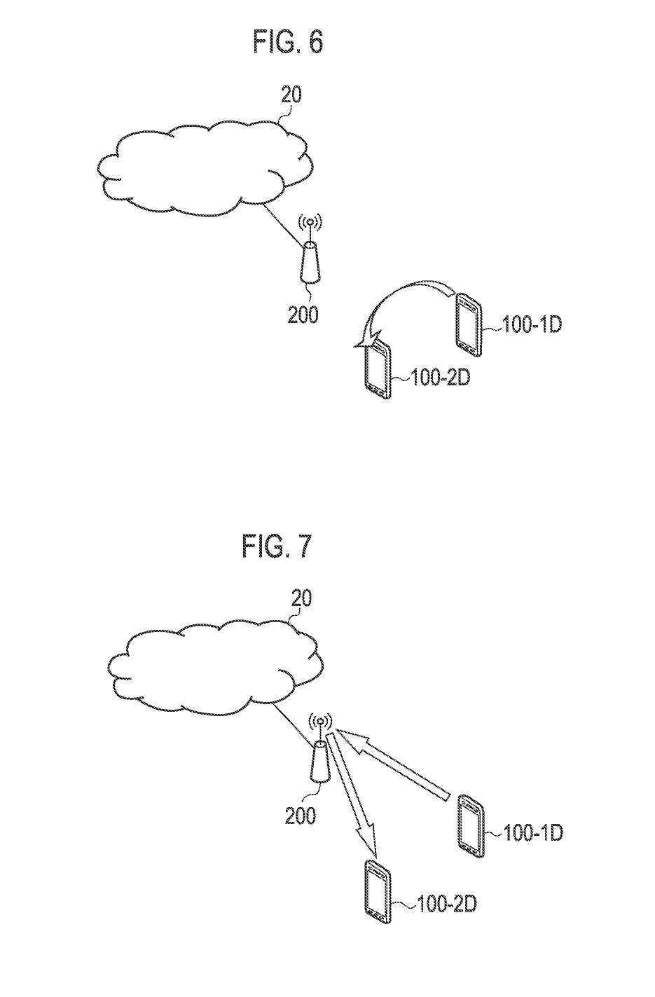

FIG. 6 is a diagram for describing the direct communication mode in the D2D communication. As illustrated in FIG. 6, in the direct communication mode, a data path does not pass through the eNB 200 UE 100-1D and UE 100-2D adjacent to each other directly perform radio communication with low transmission power in a cell of the eNB 200. Thus, a merit including reduction of power consumption of the UE 100 and decrease of interference to a neighboring cell can be obtained.

FIG. 7 is a diagram for describing the locally routed mode in the D2D communication. As illustrated in FIG. 7, in the locally routed mode, a data path passes through the eNB 200, however, does not pass through the EPC 20. That is, the UE 100-1D and the UE 100-2D perform radio communication via the eNB 200 without any intervention of the EPC 20 in a cell of the eNB 200. The locally routed mode is able to reduce traffic load of the EPC 20, however, has small merit as compared with the direct communication mode. Thus, in the first embodiment, the direct communication mode is mainly assumed.

(Operation According to First Embodiment)

In the first embodiment, from the standpoint of improving frequency use efficiency, the case, in which the D2D communication is performed in a frequency band (a licensed band) of the LTE system, is assumed. In such a case, the D2D communication is performed under the control of a network.

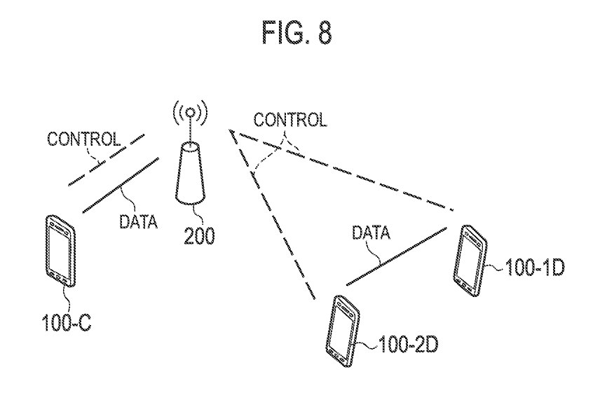

FIG. 8 is a diagram for describing an operation environment according to the first embodiment. As illustrated in FIG. 8, UE 100-C is a cellular UE (a cellular terminal) that performs the cellular communication in a cell of the eNB 200. The cellular UE 100-C in a connected state performs the cellular communication by using a radio resource that is assigned from the eNB 200. The cellular UE 100-C exchanges user data and a control signal with the eNB 200. In addition, FIG. 8 illustrates one cellular UE. However, in an actual operation environment, a plurality of cellular UEs camp on the cell of the eNB 200.

The UE 100-1D and the UE 100-2D are D2D UEs (D2D terminals) that perform the D2D communication in the cell of the eNB 200. The D2D UE 100-1D and the D2D UE 100-2D in a connected state perform the D2D communication (communication) by using a radio resource that is assigned from the eNB 200. Specifically, the D2D UE 100-1D and the D2D UE 100-2D exchange user data with each other, and exchange a control signal with the eNB 200.

As described above, in the first embodiment, the cellular UE 100-C and the D2D UE 100-D (the UE 100-1D and the UE 100-2D) camp on the same cell. However, the D2D UE, which is a part included in a D2D UE group that performs the D2D communication, may camp on another cell or may be located out of a service area.

When the D2D communication is performed in the frequency band of the LTE system, there are two schemes of a dedicated resource assignment scheme and a shared resource assignment scheme in order to ensure a radio resource (a D2D radio resource) that is assigned to the D2D communication.

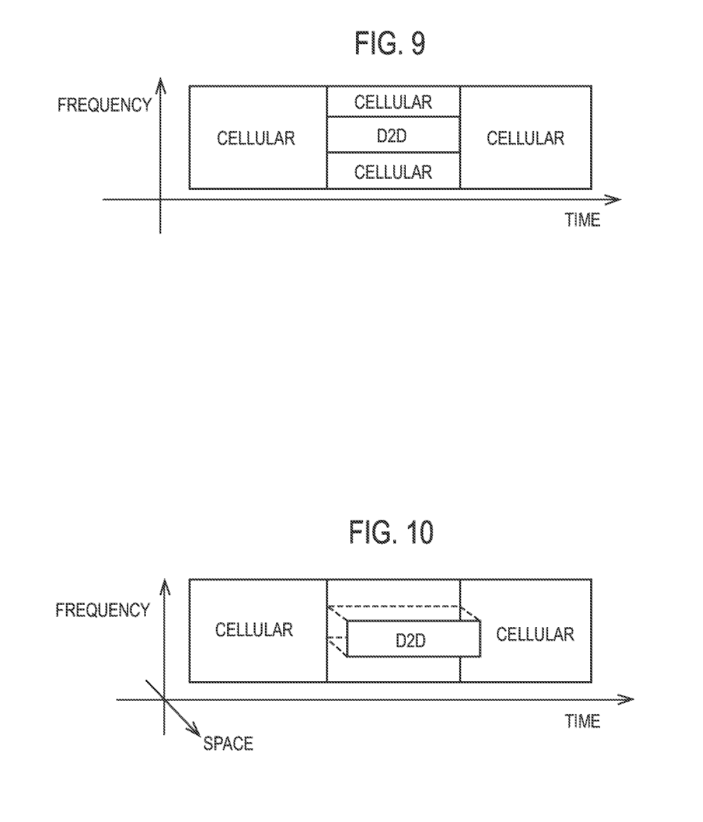

FIG. 9 is a diagram for describing the dedicated resource assignment scheme. As illustrated in FIG. 9, the dedicated resource assignment scheme is a scheme in which a D2D radio resource is not shared with a radio resource (a cellular radio resource) that is assigned to the cellular communication. In the example of FIG. 9, among radio resources (specifically, time/frequency resources) corresponding to three subframes, several resource blocks positioned at the center in the central subframe are ensured as the D2D radio resource. In this case, the D2D radio resource is a radio resource dedicated for the D2D communication. According to the dedicated resource assignment scheme, it is possible to avoid interference between the cellular communication and the D2D communication, however, the cellular radio resource relatively decreases, and thus, there is a problem that the use efficiency of the radio resource is poor.

FIG. 10 is a diagram for describing the shared resource assignment scheme. As illustrated in FIG. 10, the shared resource assignment scheme is a scheme in which the D2D radio resource is shared with the cellular radio resource. In the example of FIG. 10, among radio resources corresponding to three subframes, several resource blocks positioned at the center in the central subframe are also used as the D2D radio resource as well as the cellular radio resource . In this case, the D2D radio resource is a radio resource shared with the cellular communication. The D2D radio resource is spatially separated from the cellular radio resource. According to the shared resource assignment scheme, the use efficiency of the radio resource is high, however, there is a problem that interference easily occurs between the cellular communication and the D2D communication, that is, communication quality easily deteriorates.

In this regard, the eNB 200 according to the first embodiment devises scheduling for a plurality of cellular UEs 100-C based on the application of the shared resource assignment scheme, thereby improving the use efficiency of a radio resource while alleviating the influence of interference. Hereinafter, a cellular radio resource not shared with the D2D communication is called a “cellular-dedicated radio resource” and a cellular radio resource shared with the D2D communication is called a “D2D-shared radio resource”. The D2D-shared radio resource is a cellular radio resource that hardly causes interference with the D2D communication. On the other hand, the cellular-dedicated radio resource is a cellular radio resource that easily causes interference with the D2D communication.

The scheduler of the eNB 200 assigns the cellular-dedicated radio resource or the D2D-shared radio resource to each of a plurality of cellular UEs 100-C that perform the cellular communication.

The scheduler selects a cellular UE 100-C, to which the cellular-dedicated radio resource is assigned, from the plurality of cellular UEs 100-C according to assignment priority P1 of the cellular-dedicated radio resource. In order to calculate the assignment priority P1 of the cellular-dedicated radio resource, a first scheduling algorithm is used. The first scheduling algorithm, for example, includes proportional fairness and Max. CIR (Maximum Carrier to Interference power Ratio). The proportional fairness indicates a scheduling algorithm that increases assignment priority for a radio resource with respect to UE in which instantaneous throughput expected when the radio resource is assigned is large as compared with average throughput up to now. The Max. CIR indicates a scheduling algorithm that increases assignment priority for a radio resource with respect to UE in which CIR of the radio resource is high.

When a cellular UE 100-C, to which a cellular-dedicated radio resource is assigned, is selected from the plurality of cellular UEs 100-C, the scheduler calculates the assignment priority P1 for each of the plurality of cellular UEs 100-C by using the first scheduling algorithm. Then, the scheduler assigns the cellular-dedicated radio resource to the cellular UE 100-C with the highest assignment priority P1 among the plurality of cellular UEs 100-C.

Furthermore, the scheduler selects a cellular UE 100-C, to which the D2D-shared radio resource is assigned, from the plurality of cellular UEs 100-C according to assignment priority P2 of the D2D-shared radio resource. In this case, the scheduler calculates the assignment priority P2 for each of the plurality of cellular UEs 100-C such that the influence of interference between the cellular communication and the D2D communication is alleviated. In the first embodiment, the scheduler calculates the assignment priority P2 for each of the plurality of cellular UEs 100-C such that the D2D-shared radio resource is not continuously assigned to the same cellular UE 100-C.

In order to calculate the assignment priority P2 of the D2D-shared radio resource, a second scheduling algorithm different from the aforementioned first scheduling algorithm is used. Hereinafter, a description will be provided for an example in which an algorithm obtained by modifying the first scheduling algorithm is used as the second scheduling algorithm.

When a cellular UE 100-C, to which a D2D-shared radio resource is assigned, is selected from the plurality of cellular UEs 100-C, the scheduler calculates the assignment priority P2 for each of the plurality of cellular UEs 100-C by using the second scheduling algorithm. Then, the scheduler assigns the D2D-shared radio resource to the cellular UE 100-C with the highest assignment priority P2 among the plurality of cellular UEs 100-C.

In the first embodiment, the second scheduling algorithm is a scheduling algorithm in consideration of a passage time after the D2D-shared radio resource is finally assigned to each of the plurality of cellular UEs 100-C. In this case, for each of the plurality of cellular UEs 100-C, the scheduler manages the passage time after the D2D-shared radio resource is finally assigned.

For example, in the second scheduling algorithm, the assignment priority P2 of the D2D-shared radio resource is calculated for each of the plurality of cellular UEs 100-C through the following calculation equation.

P2=P1+α1

In the above calculation equation, the P1 is assignment priority that is calculated by the first scheduling algorithm with respect to the D2D-shared radio resource. The α1 is an adjustment value (a correction value) indicating a passage time after the D2D-shared radio resource is finally assigned.

According to the second scheduling algorithm as described above, the assignment priority P2 is adjusted to be high for a cellular UE 100-C for which the passage time after the D2D-shared radio resource is finally assigned is long. On the other hand, the assignment priority P2 is adjusted to be relatively low for a cellular UE 100-C for which the passage time is short. That is, the D2D-shared radio resource is adjusted not to be continuously assigned to the same cellular UE 100-C.

In this way, it is possible to prevent the influence of interference between the cellular communication and the D2D communication from being concentrating on the same cellular UE 100-C (and D2D UE 100-Ds adjacent to the same cellular UE 100-C). In other words, it is possible to distribute the influence of the interference between the cellular communication and the D2D communication.

Consequently, even in the case of applying the shared resource assignment scheme, it is possible to alleviate the influence of interference, so that it is possible to improve the use efficiency of a radio resource while alleviating the influence of the interference.

### Second Embodiment

Hereinafter, the second embodiment will be described while focusing on the differences from the aforementioned first embodiment. The second embodiment is different from the first embodiment in terms of a scheduling method of the D2D-shared radio resource. Other points are the same as those of the first embodiment.

In the second embodiment, the scheduler of the eNB 200 calculates the assignment priority P2 of the D2D-shared radio resource with respect to each of a plurality of cellular UEs 100-C such that the D2D-shared radio resource is preferentially assigned to a cellular UE 100-C in the vicinity of the eNB 200 among the plurality of cellular UEs 100-C.

In order to calculate the assignment priority P2 of the D2D-shared radio resource, a second scheduling algorithm different from the aforementioned first scheduling algorithm is used. Hereinafter, a description will be provided for an example in which an algorithm obtained by modifying the first scheduling algorithm is used as the second scheduling algorithm.

When a cellular UE 100-C, to which a D2D-shared radio resource is assigned, is selected from the plurality of cellular UEs 100-C, the scheduler calculates the assignment priority P2 for each of the plurality of cellular UEs 100-C by using the second scheduling algorithm. Then, the scheduler assigns the D2D-shared radio resource to the cellular UE 100-C with the highest assignment priority P2 among the plurality of cellular UEs 100-C.

In the second embodiment, the second scheduling algorithm is a scheduling algorithm in consideration of path loss (propagation loss) between each of the plurality of cellular UEs 100-C and the eNB 200. In this case, for each of the plurality of cellular UEs 100-C, the scheduler manages the path loss between each of the plurality of cellular UEs 100-C and the eNB 200. The path loss is obtained by the difference between already-known transmission power and measured reception power. Normally, path loss between the eNB 200 and a cellular UE 100-C in the vicinity of the eNB 200 is small.

For example, in the second scheduling algorithm, the assignment priority P2 of the D2D-shared radio resource is calculated for each of the plurality of cellular UEs 100-C through the following calculation equation.

P2=P1−α2

In the above calculation equation, the P1 is assignment priority that is calculated by the first scheduling algorithm with respect to the D2D-shared radio resource. The α2 is an adjustment value (a correction value) indicating path loss between the eNB 200 and each cellular UE 100-C.

According to the second scheduling algorithm as described above, the assignment priority P2 is adjusted to be low for a cellular UE 100-C with large path loss with respect to the eNB 200. On the other hand, the assignment priority P2 is adjusted to be relatively high for a cellular UE 100-C with small path loss with respect to the eNB 200. That is, the D2D-shared radio resource is adjusted to be preferentially assigned to a cellular UE 100-C in the vicinity of the eNB 200.

When the D2D-shared radio resource is provided to a downlink cellular radio resource, the D2D-shared radio resource is assigned to a cellular UE 100-C in the vicinity of the eNB 200, so that transmission power (downlink transmission power) of the eNB 200 in the D2D-shared radio resource can be suppressed to be low. In this way, it is possible to reduce the influence of interference between the D2D communication and the cellular communication.

When the D2D-shared radio resource is provided to an uplink cellular radio resource, the D2D-shared radio resource is assigned to a cellular UE 100-C in the vicinity of the eNB 200, so that transmission power (uplink transmission power) of the cellular UE 100-C in the D2D-shared radio resource can be suppressed to be low. In this way, it is possible to reduce the influence of interference between the D2D communication and the cellular communication.

Consequently, even in the case of applying the shared resource assignment scheme, it is possible to alleviate the influence of interference, so that it is possible to improve the use efficiency of a radio resource while alleviating the influence of the interference.

### Modification of Second Embodiment

In a modification of the second embodiment, a second scheduling algorithm is a scheduling algorithm in consideration of uplink transmission power with respect to each of the plurality of cellular UEs 100-C. In this case, the scheduler manages the uplink transmission power for each of the plurality of cellular UEs 100-C. Normally, uplink transmission power of a cellular UE 100-C in the vicinity of the eNB 200 is small.

In the second scheduling algorithm according to the present modification, the assignment priority P2 of the D2D-shared radio resource is calculated for each of the plurality of cellular UEs 100-C through the following calculation equation, for example.

P2=P1−α3

In the above calculation equation, the P1 is assignment priority that is calculated by the first scheduling algorithm with respect to the D2D-shared radio resource. The α3 is an adjustment value (a correction value) indicating uplink transmission power.

According to the second scheduling algorithm as described above, the assignment priority P2 is adjusted to be low for a cellular UE 100-C with large uplink transmission power. On the other hand, the assignment priority P2 is adjusted to be relatively high for a cellular UE 100-C with small uplink transmission power. That is, the D2D-shared radio resource is adjusted to be preferentially assigned to a cellular UE 100-C in the vicinity of the eNB 200.

Consequently, similarly to the aforementioned second embodiment, even in the case of applying the shared resource assignment scheme, it is possible to alleviate the influence of interference, so that it is possible to improve the use efficiency of a radio resource while alleviating the influence of the interference.

### Other Embodiments

In each of the above-described embodiments, description proceeds with an example in which as the radio resource (D2D communication radio resource) assigned by the eNB 200 to the UE 100 for the D2D communication, the radio resource (radio resource for communication) used for exchanging the user data; however, this is not limiting. The D2D radio resource may be a radio resource for another application relating to the D2D communication. For example, the D2D radio resource may be a radio resource (radio resource for discovery/discoverable) used for discovering another UE 100 existing in the vicinity of the UE 100 (or for being discovered). Further, the D2D radio resource may be a radio resource used in transmitting the synchronization signal for the D2D UEs to synchronize with each other for the D2D communication, and a radio resource used for exchanging assignment information (Scheduling Assignment) indicating an assigned location of the user data for D2D communication in which the D2D UE 100 performs the scheduling.

In each of the aforementioned embodiments, the algorithm obtained by modifying the first scheduling algorithm is used as the second scheduling algorithm. However, the second scheduling algorithm may be completely different from the first scheduling algorithm. p In the above-described first embodiment, the scheduler calculates the assignment priority P2 for each of the plurality of cellular UEs 100-C so that the D2D-shared radio resource is not continuously assigned to the same cellular UE 100-C; however, the scheduler may calculate the assignment priority P2 for each of the plurality of cellular UEs 100 so that the D2D-shared radio resource is not periodically continuously assigned to the same cellular UE 100-C. For example, the assignment priority P2 of the D2D-shared radio resource is calculated in accordance with the following calculation equation:

P2=P1+α1′

In the above calculation equation, the P1 is assignment priority that is calculated by the first scheduling algorithm, with respect to the D2D-shared radio resource. The α1′ is an adjustment value (correction value) indicating a cycle of the D2D-shared radio resource assigned to the cellular UE 100-C (that is, an interval of the D2D-shared radio resource assigned to the same cellular UE 100-C).

Therefore, for example, it is possible to avoid a case where a radio resource (for example, a VoIP radio resource) periodically continuously assigned by semi-persistent scheduling and the D2D-shared radio resource assigned to the same cellular UE 100-C continuously overlap. As a result, it is possible to prevent the influence of interference between the cellular communication and the D2D communication from being concentrating on the same cellular UE 100-C (and D2D UE 100-Ds adjacent to the same cellular UE 100-C).

In the above-described second embodiment, the second scheduling algorithm is a scheduling algorithm that takes into consideration a path loss between the eNB 200 and each of the plurality of cellular UEs 100-C; however, this is not limiting. Specifically, it may be possible to use a scheduling algorithm which takes into consideration not only a path loss (hereinafter, “first path loss”) between each of the plurality of cellular UEs 100-C and the eNB 200 but also a path loss (hereinafter, “second path loss”) between each of the plurality of cellular UEs 100-C and another eNB 200 located in the vicinity of the eNB 200.

For example, the assignment priority P2 of the D2D-shared radio resource is calculated in accordance with the following calculation equation:

P2=P1+α2′

In the above calculation equation, the P1 is assignment priority that is calculated by the first scheduling algorithm, with respect to the D2D-shared radio resource. The α2′ is an adjustment value (correction value) indicating a smaller path loss of the first path loss and the second path loss. For example, the eNB 200 acquires information indicating the second path loss from another eNB 200 to calculate α2′.

When the above-described scheduling algorithm is used, the cellular UE 100-C in which both the first path loss and the second path loss are large is adjusted so that the assignment priority P2 is low. On the other hand, the cellular UE 100-C in which either one of the first path loss or the second path loss is small is adjusted so that the assignment priority P2 is relatively high. That is, it is adjusted so that the D2D-shared radio resource is preferentially assigned to the cellular UE 100-C in the vicinity of either one of the eNB 200 or the other eNB 200. Consequently, even in the case of applying the shared resource assignment scheme, it is possible to alleviate the influence of interference, so that it is possible to improve the use efficiency of a radio resource while alleviating the influence of the interference.

The scheduling algorithm in consideration of the above-described first path loss and second path loss may be used only for the following cellular UE 100-C.

Firstly, the above-described scheduling algorithm may be used in a cellular UE 100-C in which (the cell managed by) the eNB 200 and (the cell managed by) another eNB 200 function as a CoMP (Coordinated Multi-Point) cooperation set in the uplink, out of the plurality of cellular UEs 100-C. When the eNB 200, in cooperation with the other eNB 200, receives the uplink signal from the cellular UE 100-C, either one of the eNB 200 or the other eNB 200 may suffice to receive the uplink signal from the cellular UE 100-C, and thus, the cellular UE 100-C in which either one of the first path loss or the second path loss is small is capable of making adjustment so that the assignment priority P2 is relatively high. In particular, the above-described scheduling algorithm preferably is used for the cellular UE 100-C applied with JR-CoMP (Joint reception CoMP) in which the uplink signal from the cellular UE 100-C is received jointly by the eNB 200 and the other eNB 200.

It is noted that the eNB 200 may transmit an instruction to control the transmission power, to the cellular UE 100-1 in which the above-described scheduling algorithm is used.

Secondly, the above-described scheduling algorithm may be used for the cellular UE 100-C in which the transmission power is controlled in accordance with the path loss with respect to (the cell managed by) the other eNB 200, out of the plurality of cellular UEs 100-C. When the path loss between the cellular UE 100-C and the other eNB 200 is small, the cellular UE 100-C lowers the transmission power in accordance with the second path loss when the second path loss is smaller, and thus, the cellular UE 100-C in which either one of the first path loss or the second path loss is small is capable of making adjustment so that the assignment priority P2 is relatively high.

It is noted that the eNB 200 may transmit an instruction to control the transmission power, to the cellular UE 100-C in which the above-described scheduling algorithm is used.

Further, similarly to the above-described modification of the second embodiment, it may be possible to use an algorithm that takes into consideration the uplink transmission power to the other eNB 200 in addition to the uplink transmission power to the eNB 200. In this case, the scheduler calculates, for each of the plurality of cellular UEs 100-C, the assignment priority on the basis of the uplink transmission power to the eNB 200 and the uplink transmission power to the other eNB 200. The eNB 200 adjusts the assignment priority so that the assignment priority is higher as either one of the uplink transmission power to the eNB 200 or the uplink transmission power to the other eNB 200 is smaller.

It is noted that the other eNB 200 is capable of using the same frequency band as that of the eNB 200. The other eNB 200 is a neighboring eNB 200 or eNB 200 that is arranged in a cell managed by the eNB 200 and manages a small cell, for example.

Further, the eNB 200 and the other eNB 200 maybe capable of using a Dual Connectivity scheme with which the UE 100 establishes a data path used for transmitting the user data, with each of the eNB 200 and the other eNB 200. Further, the eNB 200 and the other eNB 200 may be a CoMP cooperating set in which one time/frequency resource is used to cooperatively perform communication with the UE 100. Further, the eNB 200 may use, as a component carrier in Carrier Aggregation, a frequency band (carrier) available for the other eNB 200.

Further, in each of the above-described embodiments, the scheduler of the eNB 200 uses each of the scheduling algorithms to assign the radio resource; however, this is not limiting. For example, in a D2D UE cluster including a plurality of UEs 100 adjacent to one another, when a cluster head (CHUE) that is UE that controls the D2D communication (specifically, a control unit of the CHUE having a scheduling function) assigns a D2D radio resource to the D2D UE 100 belonging to the cluster, each of the above-described scheduling algorithms may be used.

Specifically, a case is assumed where the D2D radio resource is divided into: a dedicated cluster D2D radio resource exclusively used by one cluster (that is, a D2D radio resource not shared with another cluster); and a shared cluster D2D radio resource used commonly by a plurality of clusters (that is, a D2D radio resource shared with another cluster). In such a case, in much the same way as in the above-described scheduling, the CHUE 100-1 calculates the assignment priorities (P1, P2) to enable assignment of the dedicated cluster D2D radio resource or the shared cluster D2D radio resource to each of the plurality of D2D UEs 100 (including the CHUE 100-1) belonging to the cluster of the CHUE 100-1. As a result, even when the plurality of clusters share and use the D2D radio resource, it is possible to alleviate the influence of the interference among the clusters, and thus, it is possible to improve the use efficiency of the D2D radio resource while alleviating the influence of the interference.

It is noted that when the scheduling method according to each of the above-described embodiments is applied to the scheduling of the CHUE, the “dedicated cluster D2D radio resource” corresponds to the above-described “cellular-dedicated radio resource”, the “shared cluster D2D radio resource” corresponds to the above-described “D2D-shared radio resource”, the “scheduler of the CHUE 100-1” corresponds to the above-described “scheduler of the eNB 200”, and the “plurality of D2D UEs 100 belonging to the cluster of the CHUE 100-1” corresponds to the above-described “plurality of cellular UEs 100-C”.

Each of the aforementioned embodiments has described an example in which the present invention is applied to the LTE system. However, the present invention may also be applied to systems other than the LTE system, as well as the LTE system.

In addition, the entire content of U.S. Provisional Application No. 61/765,901 (filed on Feb. 18, 2013) is incorporated in the present specification by reference.

### INDUSTRIAL APPLICABILITY

As described above, the base station and the processor according to the present invention can improve the use efficiency of a radio resource while alleviating the influence of interference, and thus are useful for a mobile communication field.

1. A base station configured to be used in a mobile communication system that supports cellular communication in which a data path passes through a core network, and D2D communication that is direct device-to-device communication in which a data path does not pass through the core network, comprising:
a controller configured to assign a dedicated radio resource not shared with the D2D communication or a shared radio resource shared with the D2D communication to each of a plurality of cellular terminals that performs the cellular communication, wherein
the controller comprises: a scheduler configured to select a cellular terminal, to which the shared radio resource is assigned, from the plurality of cellular terminals according to assignment priority of the shared radio resource, and
the scheduler calculates the assignment priority for each of the plurality of cellular terminals such that influence of interference between the cellular communication and the D2D communication is alleviated.

2. The base station according to claim 1, wherein
the scheduler calculates the assignment priority for each of the plurality of cellular terminals such that the shared radio resource is not continuously assigned to a same cellular terminal.

3. The base station according to claim 2, wherein the scheduler calculates the assignment priority for each of the plurality of cellular terminals so that the shared radio resource is not periodically continuously assigned to the same cellular terminal.

4. The base station according to claim 2, wherein
the scheduler calculates the assignment priority for each of the plurality of cellular terminals on the basis of a passage time after the shared radio resource is finally assigned, and
the assignment priority is lower as the passage time is shorter.

5. The base station according to claim 1, wherein
the scheduler calculates the assignment priority for each of the plurality of cellular terminals such that the shared radio resource is preferentially assigned to a cellular terminal in the vicinity of the base station among the plurality of cellular terminals.

6. The base station according to claim 5, wherein
the scheduler calculates the assignment priority for each of the plurality of cellular terminals on the basis of path loss between the base station and each of the plurality of cellular terminals, and
the assignment priority is higher as the path loss is smaller.

7. The base station according to claim 5, wherein
the scheduler calculates the assignment priority for each of the plurality of cellular terminals on the basis of path loss between the base station and each of the plurality of cellular terminals and pass loss between another base station located in the vicinity of the base station and each of the plurality of cellular terminals, and
the assignment priority is higher as either one of the path loss with respect to the base station or the path loss with respect to the another base station is smaller.

8. The base station according to claim 7, wherein
the assignment priority for a cellular terminal in which the base station and the another base station function as a CoMP cooperating set in an uplink, out of the plurality of cellular terminals, is higher as either one of the path loss with respect to the base station or the path loss with respect to the another base station is smaller.

9. The base station according to claim 7, wherein
the assignment priority for a cellular terminal in which transmission power is controlled according to the path loss with respect to the another base station, out of the plurality of cellular terminals, is higher as either one of the path loss with respect to the base station and the path loss with respect to the another base station is smaller.

10. The base station according to claim 5, wherein
the scheduler calculates the assignment priority for each of the plurality of cellular terminals on the basis of uplink transmission power, and
the assignment priority is higher as the uplink transmission power is smaller.

11. The base station according to claim 1, wherein
in order to calculate the assignment priority of the shared radio resource, a scheduling algorithm, which is different from a scheduling algorithm used in order to calculate assignment priority of the dedicated radio resource, is used.

12. A communication control method that is used in a mobile communication system that supports cellular communication in which a data path passes through a core network, and D2D communication that is direct device-to-device communication in which a data path does not pass through the core network, comprising:
selecting, by a base station, a cellular terminal, to which a shared radio resource is assigned, from a plurality of cellular terminals that perform the cellular communication, according to assignment priority of the shared radio resource, the base station assigning a dedicated radio resource not shared with the D2D communication or the shared radio resource shared with the D2D communication to each of the plurality of cellular terminals, wherein
the base station calculates the assignment priority for each of the plurality of cellular terminals such that influence of interference between the cellular communication and the D2D communication is alleviated.
